(19) United States
(12) Patent Application Publication
(10) Pub. No.: US 2006/0140363 A1
(43) Pub. Date: Jun. 29, 2006

(54) Method and apparatus for delivering enhanced messages to a calling party

(75) Inventors: Shabbir A. Khakoo, Morganville, NJ (US); Venkatesh Krishnaswamy, Holmdel, NJ (US); Anwar A. Siddiqui, New York, NY (US); Hal B. Zenner, Fair Haven, NJ (US)

Correspondence Address: Ryan, Mason & Lewis, LLP, Suite 205, 1300 Post Road, Fairfield, CT, 06824, US

(73) Assignee: Avaya Technology Corp.

(21) Appl. No.: 11/355,654

(22) Filed: Feb. 16, 2006

Related U.S. Application Data
(63) Continuation of application No. 10/261,241, filed on Sep. 30, 2002.
(60) Provisional application No. 60/348,641, filed on Jan. 15, 2002.

(51) Int. Cl. H04M 1/64

(52) U.S. Cl. 379/88.22

(57) ABSTRACT

A method and apparatus are disclosed for delivering enhanced messages to a calling party. A message document address is provided to the calling party that is a pointer or hyperlink to a message document containing a message for the calling party, such as a uniform resource locator (URL) identifying an Internet document. The calling party may receive a message, e.g., when the called party is not available or containing a list of user-specific menu options in an IVR system. The message document can be (i) a static document created; (ii) a default document created; or (iii) a dynamically generated document based on one or more rules that alter the content of the document based on various characteristics of the calling party or the call (or both). The presentation of the message document address to the user can be conditioned upon the satisfaction of one or more rules, such as when the called party is unavailable or based on one or more predefined characteristics of the calling party or the call (or both).

### CROSS REFERENCE TO RELATED APPLICATIONS

This application is a continuation application of U.S. patent application Ser. No. 10/261,241, filed on Sep. 30, 2002 which claims the benefit of U.S. Provisional Application No. 60/348,641, filed Jan. 15, 2002.

### FIELD OF THE INVENTION

The present invention relates generally to communication networks, and more particularly, to methods and systems for providing enriched messaging services.

### BACKGROUND OF THE INVENTION

Most telephone systems provide a voice mail feature or another mechanism for recoding messages when the called party is not available. Typically, when the called party is not available, the calling party is presented with a greeting that indicates that the called party is not available and that invites the calling party to leave a message. Once the calling party has recorded a message, the called party (i.e., the message recipient) can thereafter retrieve the recorded message at his or her convenience. The greeting that is presented to the calling party is generally a standard greeting that is not specific to the calling party or the call itself.

Similarly, when a person calls a business, the telephone call is often initially answered by an automated agent that presents the caller with a standard greeting. Businesses often employ an interactive voice response (IVR) system that efficiently provides callers with information in the form of recorded messages and obtains information from callers using keypad or voice responses to recorded queries. Such IVR systems typically answer a telephone call and provide a standard greeting to the caller that includes a menu of options that are available to the caller. For example, the menu of options typically indicates the set of options that are associated with the buttons on the telephone keypad. The menu of options that is presented to the calling party is generally a standard list that is not specific to the calling party or the call itself.

A need therefore exists for a method and apparatus for delivering enhanced messaging services to a calling party. A further need exists for a method and apparatus for delivering a message to a calling party that is based on properties of the telephone call.

### SUMMARY OF THE INVENTION

Generally, a method and apparatus are disclosed for delivering enhanced messages to a calling party. The present invention provides a message document address to the calling party that is a pointer or hyperlink to a message document containing a message for the calling party. The message document address may be, for example, a uniform resource locator (URL) identifying an Internet document or a database address identifying a database document or entry. Thus, the present invention provides a convenient mechanism for providing information to a calling party, such as a message for the calling party when the called party is not available or a list of user-specific menu options in an IVR system.

The message document generally contains information that the called party would like to be presented to the calling party and may be stored by the called party or accessed over a network, such as a web page that may be accessed over the Internet. The message document can be (i) a static document created, for example, by or on behalf of the called party; (ii) a default document created, for example, in accordance with predefined document content rules; or (iii) a dynamically generated document based on one or more rules that alter the content of the document based on various characteristics of the calling party or the call (or both). In addition, the presentation of the message document address to the user can be conditioned upon the satisfaction of one or more rules, such as providing the message document address only when the called party is unavailable or based on one or more predefined characteristics of the calling party or the call (or both).

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary network environment in which the present invention can operate;

FIG. 2 is a schematic block diagram of an exemplary switch incorporating features of the present invention;

FIG. 3 illustrates an exemplary exchange of signals between the calling party and the switch of FIG. 1 in accordance with one embodiment of the present invention;

FIG. 4 is a flow chart describing an exemplary enhanced message handling process implemented by the switch of FIG. 1; and

FIG. 5 illustrates the processing of the message document address by the calling party.

### DETAILED DESCRIPTION

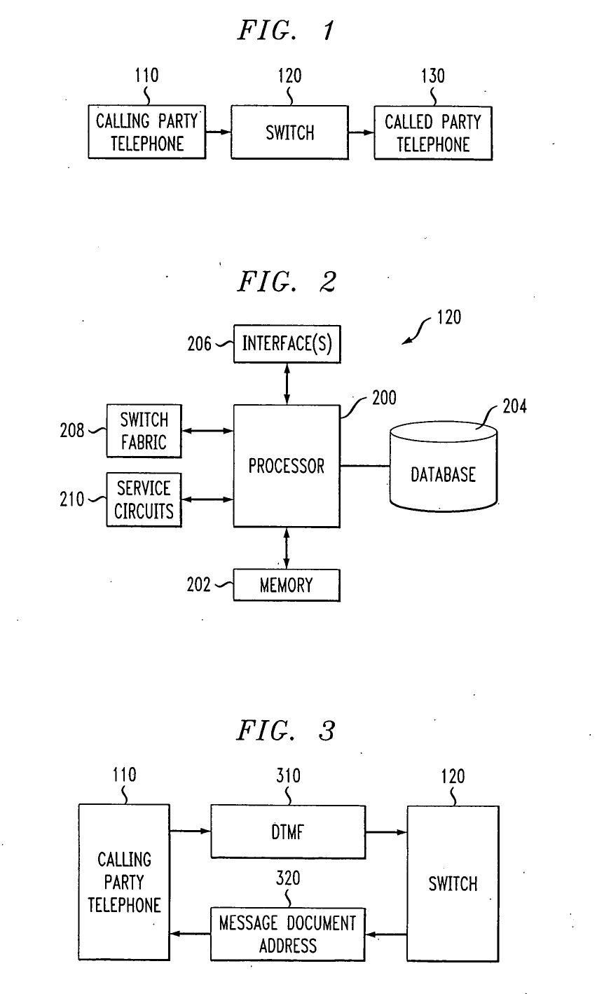

FIG. 1 illustrates an exemplary network environment in which the present invention can operate. As shown in FIG. 1, a calling party 110 calls a called party 130 and the call is routed through at least one switch 120, discussed below in conjunction with FIG. 2. According to one aspect of the present invention, a message document address is presented to the calling party 110 that is a pointer or hyperlink to a message document containing a message for the calling party, such as a web page that may be accessed over the Internet. Thus, the message document address may be, for example, a uniform resource locator (URL) identifying an Internet document or a database address identifying a database document or entry.

The document identified by the message document address contains appropriate information that the called party 130 would like to be presented to the calling party 110, for example, on the telephone of the calling party 110 or an associated computing device or display, such as a personal computer or personal digital assistant (PDA). The message document may include text, images or audio or any combination of the foregoing. As discussed herein, the present invention is particularly suitable for use with available and emerging Internet technologies, such as the hypertext transfer protocol (HTTP) or a similar Internet protocol for accessing documents, voice over IP (VoIP) or the Session Initiation Protocol (SIP), described, for example, in M. Handley et al., “SIP: Session Initiation Protocol,” RFC 2543 (March 1999).

As discussed further below, the called party 130 can optionally specify one or more message generation rules that determine whether a message is sent to the calling party 110. In addition, the called party 130 can optionally specify one or more message content rules that determine the content of the message that is sent to the calling party 110. For example, a message generation rule can specify that a message should be sent to the calling party 110 only if the called party 130 is unavailable. A message content rule can indicate the content of the document based on various characteristics of the calling party or the call (or both). Similarly, a message generation rule for an IVR implementation can specify that a message should be sent to each calling party 110 with a list of menu options that are tailored to the calling party 110 or other properties of the call, such as the time of day or the location of the calling party 110.

While the present invention is illustrated below in conjunction with the processing of calls in an exemplary enterprise communication system, it is not limited to use with any particular configuration of system elements or communication processing application. Those skilled in the art will recognize that the disclosed techniques may be used in any communication system application in which it is desirable to provide enhanced messaging services to a calling party 110. Thus, the term “switch” as used herein should be understood to include a private-branch exchange (PBX) system, an enterprise switch, or other type of telecommunications system switch, as well as other types of processor-based communication control devices. The term “call” as used herein is intended to include not only incoming or outgoing telephone calls but also non-telephonic communications such as data transmissions, voice-over-IP, e-mail or facsimile.

FIG. 2 is a schematic block diagram of an exemplary switch 120 incorporating features of the present invention. The switch 120 may be embodied, for example, as a DEFINITY® Enterprise Communication Service (ECS) communication system switch, available from Avaya Inc. of Basking Ridge, N.J., USA, as modified herein to provide the features and functions of the present invention. While the present invention is illustrated in the context of a SIP-enabled switch 120, other types of known switches may be utilized, as modified herein to support the features and functions of the present invention. In particular, such known switches must be extended to support the direction of a called party's document address identifier to the calling party 110 with a call in accordance with the present invention. The conventional aspects of such switches are well known in the art and therefore not described in detail herein. The switch 120 may be connected to one or more external endpoints, e.g., external terminals or system processing elements, via a network (not shown) or other suitable communication channel(s).

As shown in FIG. 2, the exemplary switch 120 includes a processor 200, a memory 202, a database 204, one or more interfaces 206, a switch fabric 208, and a set of service circuits 210. The processor 200 may be implemented as a central processing unit (CPU), microprocessor, application-specific integrated circuit (ASIC) or other type of digital data processor, as well as various portions or combinations of such elements. The memory 202 may be a random access memory (RAM), a read-only memory (ROM) or combinations of these and other types of electronic memory devices.

The processor 200 operating in conjunction with the memory 202 executes one or more software programs for providing processing and other functions within the switch 120. Such programs may be stored in memory 202 or another storage device accessible to the switch 120 and executed by processor 200 in a conventional manner.

The database 204 may be, e.g., an optical or magnetic disk-based storage device, or other conventional storage device associated with or otherwise accessible to the switch 120. The database 204 may be used to store, e.g., feature assignments to particular feature buttons or codes, directory number assignments to corresponding call appearances or direct facility termination keys, access restrictions, and other administrative information regarding the configuration of the system, as well as other types of information. The service circuits 210 may include tone generators, announcement circuits, etc. These circuits and the interfaces 206 are controlled by processor 200 in implementing call processing functions in the switch 120.

The switch 120 may include additional elements that are omitted from FIG. 2 for simplicity and clarity of illustration. For example, the switch may include a port card for each type of user terminal associated therewith. In addition, it will be appreciated by those skilled in the art that the switch 120 may be configured to support multiple user terminals of different types, e.g., wired deskset terminals, wireless deskset terminals, personal computers, video telephones or other advanced terminals, etc. Also associated with the switch 120 may be an administrator terminal (not shown) that is used to program the operation of the switch 120 during a system administration, e.g., an initial set-up and configuration of the system or a subsequent system-level or user-level reconfiguration.

Other devices not shown in the figures may be associated with the switch 120, such as an adjunct feature server. Such an adjunct may be physically incorporated within the switch, and may be partially or completely implemented using other switch elements such as processor 200 and memory 202.

FIG. 3 illustrates the exchange of signals between the calling party 110 and the switch 120 in accordance with one embodiment of the present invention. As shown in FIG. 3, an exemplary dual tone multiple frequency (DTMF) signal 310 is transmitted from the calling party 110 to the switch 120. The DTMF signal 310 corresponds to the telephone number of the called party 130, as entered by the calling party 110 using the keypad of the telephone, in a known manner.

In addition, in accordance with the present invention, the switch 120 presents a message document address 320 to the calling party 110 that is a pointer or hyperlink to a message document containing a message for the calling party, such as a web page that may be accessed over the Internet. The presentation of the message document address 320 to the calling party 110 by the switch 120 can be conditioned upon the satisfaction of one or more rules, such as when the called party is unavailable or based on one or more predefined characteristics of the calling party or the call (or both). It is noted that the message document address 320 may be included in the signal by the telephone of the called party 130 or by the switch 120, as would be apparent to a person of ordinary skill in the art.

According to another aspect of the present invention, the message document identified by the address 320 can be (i) a static document created, for example, by the called party 130 or someone on behalf of the called party 130, such as a system administrator of the called party 130; (ii) a default document created, for example, in accordance with a policy of the employer or telephone service provider of the called party 130 (for example, a message document created in accordance with a default policy may always include the name, telephone number, photograph, corporate identifier and company logo of the called party 130); or (iii) a dynamically generated document based on one or more rules. The dynamically generated document based on one or more rules may alter the content of the document based on various characteristics of the calling party 110, such as corporate affiliation or geographic location, or characteristics of the call, such as time of day.

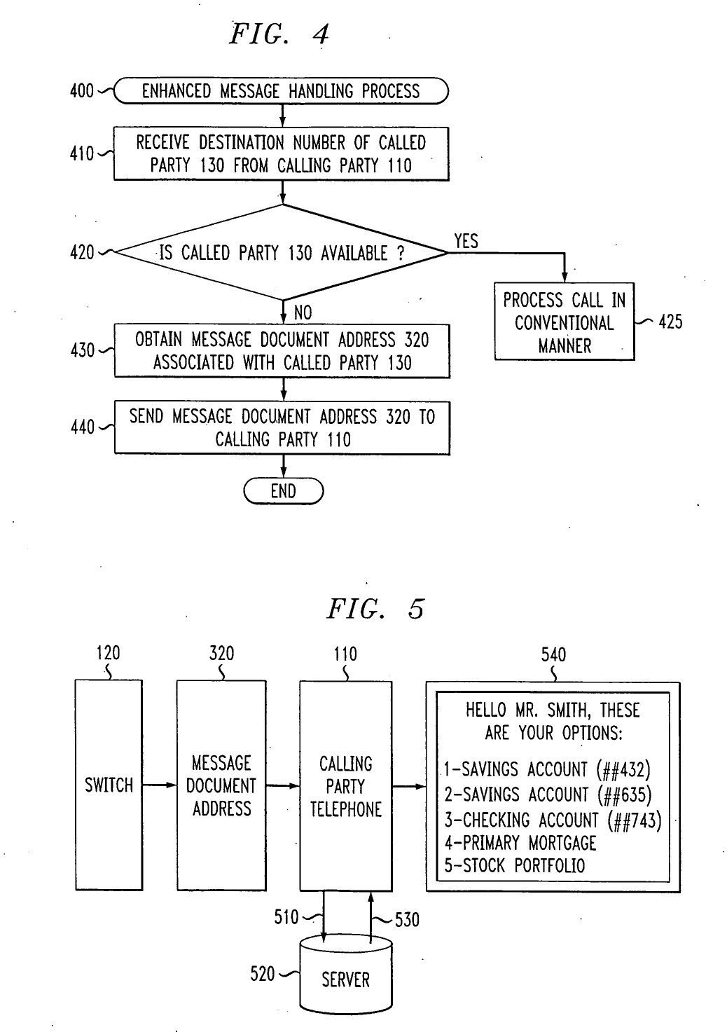

FIG. 4 is a flow chart describing an exemplary enhanced message handling process 400 implemented by the switch 120 of FIG. 1. As shown in FIG. 4, the switch 120 initially receives the destination number of the called party 130 during step 410. A test is performed during step 420 to determine if the telephone of the called party 130 identified by the received destination number is available. If it is determined during step 420 that the telephone of the called party 130 is available, then the telephone call is handled in a conventional manner during step 425.

If, however, it is determined during step 420 that the telephone of the called party 130 is not available, for example, if the telephone of the called party 130 is busy, then the switch 120 obtains the message document address 320 corresponding to the calling party 110 during step 430. As previously indicated, the message document address 320 may be stored by the called party 130 and appended to the signal 300 or may be retrieved by the switch 120, as would be apparent to a person of ordinary skill in the art. Thereafter, the switch 120 sends the message document address 320 to the calling party 110 during step 440, before program control terminates. The message document address may be, for example, a uniform resource locator (URL) identifying an Internet document that is accessed by the calling party 110 to obtain the desired message.

FIG. 5 illustrates the processing of the message document address 320 by the calling party 110. As shown in FIG. 5, the calling party 110 receives an incoming signal from the switch 120 that includes the message document address 320, in accordance with the present invention. The telephone unit of the calling party 110 retrieves the message document address 320 from the incoming signal and accesses the appropriate message document. In the exemplary implementation shown in FIG. 5, the calling party 110 sends an HTTP request 510 for the message document to a server 520 addressed by the message document address 320. The server provides an HTTP response 520 with the requested message document. Thereafter, the requested message document is rendered to the calling party 110, for example, on a display 540 associated with the telephone or another device of the calling party 110. In this manner, the calling party 110 obtains the URL specified by the called party 130 from the web server 520 specified in the URL (message document address 320) and displays the content of the URL to the calling party 110.

For example, the message document address 320 may be a URL, that is resolved by a domain name server (DNS) to the server 520. The appropriate document is then provided to the calling party 110 in accordance with the HTTP protocol for presentation to the calling party 110, for example, on a display associated with the telephone or another device of the calling party 110. It is noted that while the exemplary embodiments described herein contemplate the use of textual or image-based message documents, the message documents may also be embodied using other media, such as audio, in addition to or instead of text or image information.

It is to be understood that the embodiments and variations shown and described herein are merely illustrative of the principles of this invention and that various modifications may be implemented by those skilled in the art without departing from the scope and spirit of the invention.

We claim:

1. A method for providing message information to a calling party as part of a call, comprising:
obtaining a message document address identifying a message document that should be presented to said calling party;
determining if a called party associated with said call is available; and
providing said message document address to said calling party as part of said call in response to a determination that said called party is unavailable.

2. The method of claim 1, wherein said message document address is a uniform resource locator.

3. The method of claim 1, wherein said message document is a static document associated with said called party.

4. The method of claim 1, wherein said message document is a default document created in accordance with predefined default document content rules.

5. The method of claim 1, wherein said message document is a dynamic document based on one or more rules that alter the content of said message document.

6. The method of claim 1, wherein said message document address is presented to said calling party only if one or more rules are satisfied.

7. The method of claim 1, wherein said message document address is received from a called party associated with said call.

8. The method of claim 1, wherein said message document comprises one or more media.

9. A method for receiving a message from a called party as part of a call, comprising:
placing a call from a calling party to said called party;
receiving a message document address identifying a document that should be presented to said calling party if said called party is unavailable;
obtaining a message document identified by said message document address; and
presenting said message document to said calling party.

10. The method of claim 9, wherein said message document address is a uniform resource locator.

11. The method of claim 9, wherein said message document is a static document associated with said called party.

12. The method of claim 9, wherein said message document is a default document created in accordance with predefined default document content rules.

13. The method of claim 9, wherein said message document is a dynamic document based on one or more rules that alter the content of said message document.

14. The method of claim 9, wherein said message document address is presented to said calling party if one or more rules are satisfied.

15. A system for providing message information to a calling party, comprising:
a memory that stores computer-readable code; and
a processor operatively coupled to said memory, said processor configured to implement said computer-readable code, said computer-readable code configured to:
obtain a message document address identifying a message document that should be presented to said calling party;
determine if a called party associated with said call is available; and
provide said message document address to said calling party as part of said call in response to a determination that said called party is unavailable.

16. The system of claim 15, wherein said message document address is a uniform resource locator.

17. The system of claim 15, wherein said message document is a static document associated with said called party.

18. The system of claim 15, wherein said message document is a default document created in accordance with predefined default document content rules.

19. The system of claim 15, wherein said message document is a dynamic document based on one or more rules that alter the content of said message document.

20. The system of claim 15, wherein said message document address is presented to said calling party if one or more rules are satisfied.

21. A system for providing message information to a calling party, comprising:
a memory that stores computer-readable code; and
a processor operatively coupled to said memory, said processor configured to implement said computer-readable code, said computer-readable code configured to:
place a call from a calling party to said called party;
receive a message document address identifying a document that should be presented to said called party if said called party is unavailable;
obtain a message document identified by said message document address; and
present said message document to said called party.

22. A system for receiving a message from a called party, comprising:
a memory that stores computer-readable code; and
a processor operatively coupled to said memory, said processor configured to implement said computer-readable code, said computer-readable code configured to:
receive a message document address identifying a document that should be presented to said calling party if said called party is unavailable;
obtain a message document identified by said message document address; and
present said message document to said calling party.

23. An article of manufacture for providing message information to a calling party, comprising:
a computer readable medium having computer readable code means embodied thereon, said computer readable program code means comprising:
a step to obtain a message document address identifying a message document that should be presented to said calling party;
a step to determine if a called party associated with said call is available; and
a step to provide said message document address to said calling party as part of said call in response to a determination that said called party is unavailable.
